(19) United States
(12) Patent Application Publication
(10) Pub. No.: US 2025/0145822 A1
(43) Pub. Date: May 8, 2025

(54) RESIN COMPOSITION AND ARTICLE MADE THEREFROM

(71) Applicant: ELITE ELECTRONIC MATERIAL (KUNSHAN) CO., LTD., Kunshan City (CN)

(72) Inventors: Yan ZHANG, Kunshan City (CN); Zheng JIA, Kunshan City (CN); Xueyan JIANG, Kunshan City (CN)

(73) Assignee: ELITE ELECTRONIC MATERIAL (KUNSHAN) CO., LTD., Kunshan City (CN)

(21) Appl. No.: 18/431,728

(22) Filed: Feb. 2, 2024

(30) Foreign Application Priority Data
Nov. 8, 2023 (CN) 202311478260.5

(51) Int. Cl. C08L 71/12

(52) U.S. Cl. CPC C08L 71/123; C08L 2201/02; C08L 2201/08; C08L 2203/20

(57) ABSTRACT

This present disclosure provides resin composition and article made therefrom, including prepreg, resin film, laminate, or printed circuit board. Resin composition comprises: (A) 100 parts by weight of unsaturated C═C double bond-containing polyphenylene ether resin; and (B) 20 parts by weight to 100 parts by weight of phosphorus-containing polyolefine resin. Phosphorus-containing polyolefine resin consists of (a) structural unit and (b) structural unit, and/or consists of (a) structural unit, (b) structural unit and (c) structural unit, wherein (a) structural unit comprises any one of (al) structural unit, (a2) structural unit, or combination thereof, and (b) structural unit comprises any one of (bi) structural unit, (b2) structural unit, or combination thereof. Article has improvement in at least one of following properties: stickiness resistance, glass transition temperature, copper foil peeling strength, dielectric properties, water absorption rate, flame retardancy, thermal resistance after moisture absorption, appearance of laminate, alkali resistance.

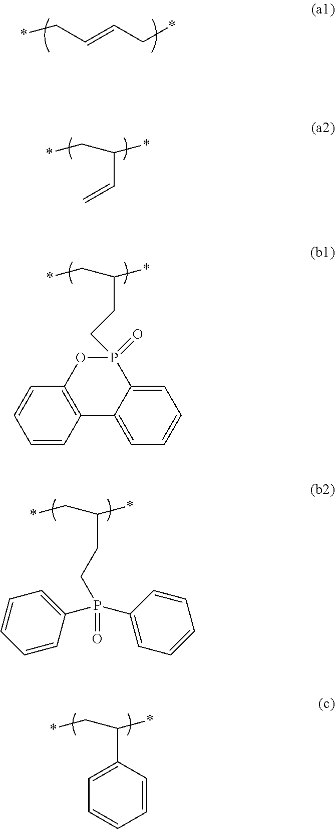

### CROSS-REFERENCE TO RELATED APPLICATIONS

This non-provisional application claims priority under 35 U.S.C. § 119(a) on Patent Application No. 202311478260.5 filed in China on Nov. 8, 2023, the entire contents of which are hereby incorporated by reference.

### BACKGROUND

### 1. Technical Field

This disclosure relates to a resin composition and an article made therefrom, particularly to a resin composition applicable to a prepreg, a resin film, a laminate, and a printed circuit board.

### 2. Related Art

With the rapid development of mobile communication technology, servers, cloud storage, and other electronic products, resin materials suitable for high-speed information transmission have gradually become the main development direction of laminates. The copper-clad laminate material is required to have high glass transition temperature, high copper foil peeling strength, low dielectric constant and dissipation factor, low water absorption rate, high flame retardancy, excellent thermal resistance after moisture absorption, preferable laminate appearance, excellent alkali resistance, and excellent prepreg stickiness resistance to meet the requirements of high-speed information transmission.

However, current high-speed materials mainly use hydrocarbon resins such as ordinary polyolefins as the main resin, combined with traditional additive flame retardants. Using the laminate made from this kind of resin composition cannot meet the above requirements at the same time. Therefore, it is necessary to develop materials suitable for preferable printed circuit board (PCB) with comprehensive performance.

### SUMMARY

In view of the above technical problems in the prior art, particularly the problem that the current material cannot meet one or more of the above performance requirements, the main purpose of the present disclosure is to provide at least one resin composition capable of solving the problems described above, and an article, such as, a prepreg, a resin film, a laminate, printed circuit board, made therefrom.

The resin composition of the present disclosure, comprising:
(A) 100 parts by weight of an unsaturated C═C double bond-containing polyphenylene ether resin; and
(B) 20 parts by weight to 100 parts by weight of a phosphorus-containing polyolefin resin, wherein the phosphorus-containing polyolefin resin consists of (a) structural unit and (b) structural unit, and/or, consists of (a) structural unit, (b) structural unit, and (c) structural unit, wherein (a) structural unit comprises any one of (a1) structural unit, (a2) structural unit, or a combination thereof, (b) structural unit comprises any one of (b1) structural unit, (b2) structural unit, or a combination thereof,

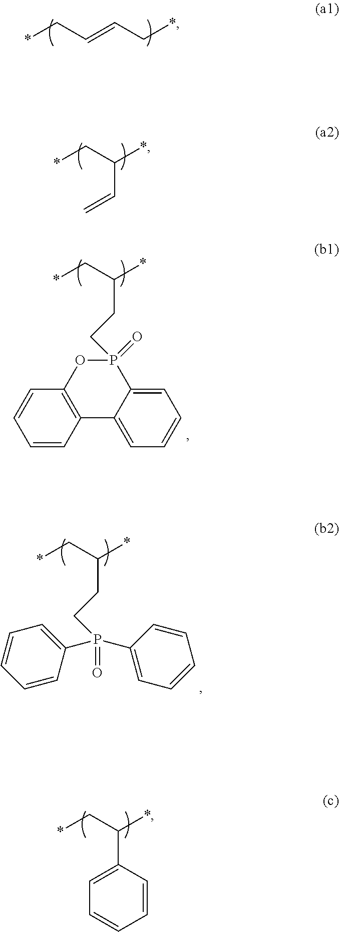

wherein symbol “*” represents a bonding position between the structural units.

In one exemplary embodiment, the unsaturated C═C double bond-containing polyphenylene ether resin comprises any one of a vinylbenzyl group-containing polyphenylene ether resin, a (meth)acryloyl group-containing polyphenylene ether resin, a vinyl group-containing polyphenylene ether resin, or a combination thereof.

In one exemplary embodiment, the phosphorus content in the phosphorus-containing polyolefin resin is 3 to 10 percentage by weight (wt %).

In one exemplary embodiment, the phosphorus content in the phosphorus-containing polyolefin resin is 3.1 to 4.0 percentage by weight (wt %).

In one exemplary embodiment, the phosphorus-containing polyolefin resin comprises any one of a phosphorus-containing polyolefin resin represented by Formula (1), a phosphorus-containing polyolefin resin represented by Formula (2), a phosphorus-containing polyolefin resin represented by Formula (3), a phosphorus-containing polyolefin resin represented by Formula (4), a phosphorus-containing polyolefin resin represented by Formula (5), a phosphorus-containing polyolefin resin represented by Formula (6), a phosphorus-containing polyolefin resin represented by Formula (7), a phosphorus-containing polyolefin resin represented by Formula (8), or a combination thereof,

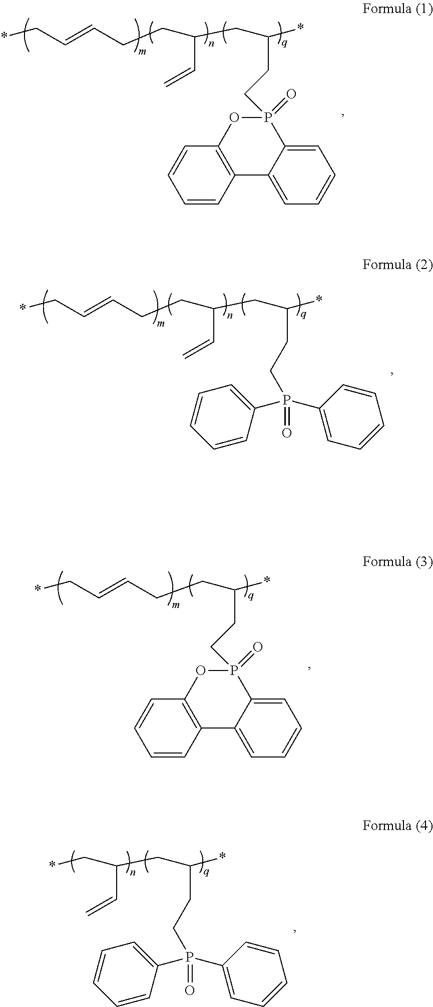

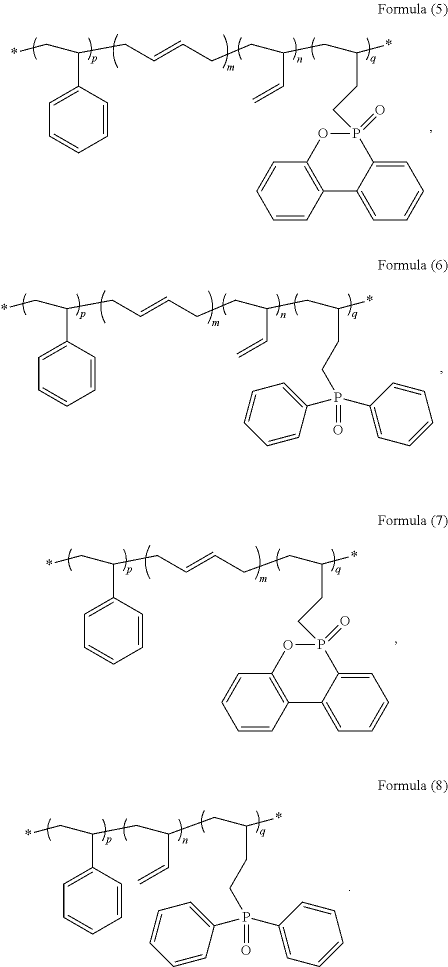

In one exemplary embodiment, in Formula (1) to Formula (8), symbol “*” represents a bonding position between the structural units, and each of p, m, n, or q is independent, wherein p is an integer of 1 to 200, m is an integer of 2 to 200, n is an integer of 10 to 400, q is an integer of 1 to 100.

In one exemplary embodiment, the resin composition further comprises an unsaturated C═C double bond-containing crosslinking agent, and the unsaturated C═C double bond-containing crosslinking agent is any one of a bis(vinylphenyl)ethane, a bis(vinylbenzyl) ether, a divinylbenzene, a divinylnaphthalene, a divinylbiphenyl, a triallyl isocyanurate, a triallyl cyanurate, a trivinylcyclochexane, a diallyl bisphenol A, a butadiene, a decadiene, an octadiene, an acrylate having two or more functional groups, or a combination thereof.

In one exemplary embodiment, the resin composition further comprises any one of a phosphorus-free polyolefin, a maleimide resin, a benzoxazine resin, an epoxy resin, an organic silicone resin, a cyanate ester resin, an active ester, a phenol resin, an amine curing agent, a styrene maleic anhydride, a polyamide, a polyimide, or a combination thereof.

In one exemplary embodiment, the resin composition further comprises any one of a flame retardant, a curing accelerator, a polymerization inhibitor, an inorganic filler, a solvent, a silane coupling agent, a surfactant, a coloring agent, a toughening agent, or a combination thereof.

The present disclosure further provides an article made from the above resin composition, wherein the article comprises a prepreg, a resin film, a laminate, or a printed circuit board.

In one exemplary embodiment, the article having at least one of the following properties:
after vacuum-packed, neither stickiness nor powder falling occurs in the prepreg after it has been placed at 40° C. for 2 hours,
a dielectric constant at 10 GHz as measured by reference to JISC2565 of less than or equal to 3.30,
a dissipation factor at 10 GHz as measured by reference to JISC2565 of less than or equal to 0.0030,
a glass transition temperature as measured by reference to IPC-TM-650 2.4.24.4 of greater than or equal to 200° C.,
a flame retardancy as measured by reference to UL94 rating of V0,
no delamination occurs after subjecting the article to a thermal resistance after moisture absorption test by reference to IPC-TM-650 2.6.16.1 and IPC-TM-650 2.4.23,
a water absorption rate as measured by reference to IPC-TM-650 2.6.2.1 and IPC-TM-650 2.6.16.1 of less than or equal to 0.30%,
a copper foil peeling strength as measured by reference to IPC-TM-650 2.4.8 of greater than or equal to 3.1 lb/in,
an alkali resistance of a laminate as measured by an alkali resistance test is greater than or equal to 10 minutes,
by visual inspection with naked eyes, it is observed that neither patterns nor yellow spots are on the laminate appearance.

The article made from the resin composition of the present disclosure has an improvement in at least one of the following properties: stickiness resistance, glass transition temperature, copper foil peeling strength, dielectric properties, water absorption rate, flame retardancy, thermal resistance after moisture absorption, laminate appearance, alkali resistance.

### DETAILED DESCRIPTION

All technical and scientific terms used herein have the common meaning as understood by those skilled in the art. Unless otherwise specified, the terms defined herein shall prevail.

The terms “comprise,” “include,” “contain,” “have,” or the like belongs to open-ended transitional phrase (i.e., other elements not listed herein may be contained). The terms “consisting of,” “composed by,” “remainder being,” or the like belongs to close-ended transitional phrases.

For the convenience of the description, numerical ranges used herein shall be understood as including all of the possible subranges and individual numerals or values therein, including integers and fractions.

The value used herein includes all of the values which will be the same as such value after being rounded off.

It should be understood that members in the Markush group can individually or combinely be used to describe the present disclosure.

A polymer used herein refers to the product formed by monomer(s) via polymerization. A polymer may include a homopolymer (also known as a self-polymer), a copolymer, a prepolymer, etc., but the present disclosure is not limited thereto. A homopolymer refers to the polymer formed by the polymerization of one monomer. A copolymer refers to the polymer formed by the polymerization of two or more monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For instance, a styrene-butadiene copolymer comprises a styrene-butadiene random copolymer, a styrene-butadiene alternating copolymer, a styrene-butadiene graft copolymer, or a styrene-butadiene block copolymer. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes an oligomer, but the present disclosure is not limited thereto. An oligomer, also known as low polymer, refers to a polymer with 2 to 20, typically 2 to 5, repeating units.

The term “resin” used herein includes monomer, polymer thereof, a combination of the monomer, a combination of the polymer, or a combination of the monomer and the polymer, but the present disclosure is not limited thereto.

A modification described herein includes a modification includes a product derived from a resin with its reactive functional group modified, a product derived from a prepolymerization reaction of each resin and other resins, a product derived from copolymerizing each resin and other resins, a product derived from crosslinking reaction of each resin and other resins or the like.

The unsaturated bonds used herein refer to reactive unsaturated bonds (e.g., unsaturated bonds capable of carrying out crosslinking reaction with other functional groups), but the present disclosure is not limited thereto.

The unsaturated C═C double bond used herein, preferably, includes a vinyl group, a vinylbenzyl group, a (meth)acryloyl group, an allyl group or a combination thereof, but the present disclosure is not limited thereto. The term “vinyl group” includes a vinyl group and a vinylidene group. The term “(meth)acryloyl group” includes an acryloyl group and a methylacryloyl group.

An alkyl group, an alkenyl group, and a monomer used herein includes any isomers thereof. For instance, a propyl group includes n-propyl group and isopropyl group.

The term “parts by weight” used herein represents the relative parts by weight in the composition, which may be any weight unit, such as kilogram, gram, pound or the like, but the present disclosure is not limited thereto. For instance, 100 parts by weight of an unsaturated C═C double bond-containing polyphenylene ether resin may represent 100 kilograms of the unsaturated C═C double bond-containing polyphenylene ether resin or 100 pounds of the unsaturated C═C double bond-containing polyphenylene ether resin.

The term “wt %” used herein represents percentage by weight (or mass).

It should be understood that as long as there is no contradiction, each of the features of the exemplary embodiments described herein may be individually or combinely combined with each other.

It should be understood that the exemplary embodiments described herein are exemplary in all aspects and are not intended to limit the scope of the present disclosure. Therefore, the scope of the present disclosure is not limited to the exemplary embodiments.

As described above, the present disclosure mainly discloses a resin composition, comprising:
(A) 100 parts by weight of an unsaturated C═C double bond-containing polyphenylene ether resin; and
(B) 20 parts by weight to 100 parts by weight of a phosphorus-containing polyolefin resin, wherein the phosphorus-containing polyolefin resin consists of (a) structural unit and (b) structural unit, and/or, consists of (a) structural unit, (b) structural unit, and (c) structural unit, wherein (a) structural unit comprises any one of (a1) structural unit, (a2) structural unit, or a combination thereof, (b) structural unit comprises any one of (b1) structural unit, (b2) structural unit, or a combination thereof (wherein symbol “*” represents a bonding position between the structural units).

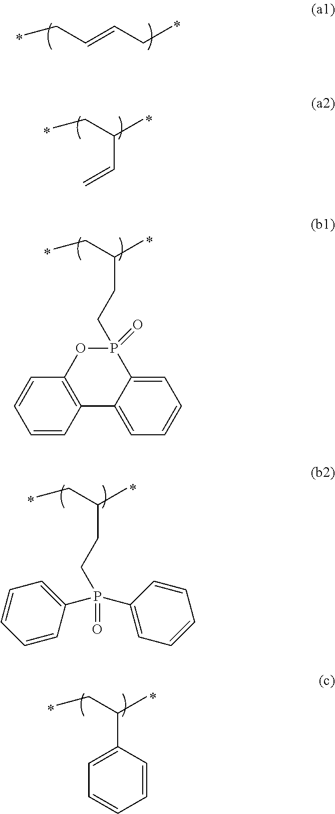

In one exemplary embodiment, compared to 100 parts by weight of the unsaturated C═C double bond-containing polyphenylene ether resin, the resin composition of the present disclosure comprises 20 parts by weight to 100 parts by weight of the phosphorus-containing polyolefin resin, such as 20 parts by weight, 30 parts by weight, 40 parts by weight, 50 parts by weight, 60 parts by weight, 70 parts by weight, 80 parts by weight, 90 parts by weight, or 100 parts by weight of the phosphorus-containing polyolefin resin, but the present disclosure is not limited thereto.

The phosphorus-containing polyolefin resin may consist of (a) structural unit and (b) structural unit, or may consist of (a) structural unit, (b) structural unit, and (c) structural unit. The phosphorus-containing polyolefin resin may further consist of (a) structural unit and (b) structural unit, and consist of (a) structural unit, (b) structural unit, and (c) structural unit, wherein the phosphorus-containing polyolefin resin consisting of (a) structural unit and (b) structural unit may be a phosphorus-containing polyolefin resin consisting of (a) structural unit and (b) structural unit, or may be a mixture of multiple phosphorus-containing polyolefin resins consisting of (a) structural unit and (b) structural unit; the phosphorus-containing polyolefin resin consisting of (a) structural unit, (b) structural unit, and (c) structural unit may be a phosphorus-containing polyolefin resin consisting of (a) structural unit, (b) structural unit, and (c) structural unit, or may be a mixture of multiple phosphorus-containing polyolefin resins consisting of (a) structural unit, (b) structural unit, and (c) structural unit. The phosphorus-containing polyolefin resin consisting of (a) structural unit and (b) structural unit and consisting of (a) structural unit, (b) structural unit, and (c) structural unit may be a mixture of one or more phosphorus-containing polyolefin resins consisting of (a) structural unit and (b) structural unit and one or more phosphorus-containing polyolefin resins consisting of (a) structural unit, (b) structural unit, and (c) structural unit.

The unsaturated C═C double bond-containing polyphenylene ether resin applicable to the present disclosure, may be any one or more of unsaturated C═C double bond-containing polyphenylene ether resins applicable to the production of a prepreg, a resin film, a laminate, or a printed circuit board, and may be any one or more of commercial products, self-prepared products, or a combination thereof, such as vinylbenzyl group-containing polyphenylene ether resin, (meth)acryloyl group-containing polyphenylene ether resin, vinyl group-containing polyphenylene ether resin, or a combination thereof, but the present disclosure is not limited thereto.

All the unsaturated C═C double bond-containing polyphenylene ether resins of the present disclosure have unsaturated C═C double bonds and a backbone of phenyl ether, wherein the unsaturated C═C double bonds are reactive functional groups, which may be self-polymerized after heated and may perform free radical polymerization with other components containing an unsaturated bond in the resin composition and finally result in crosslinking and curing. The cured products have properties of high thermal resistance and low dielectric. Preferably, the unsaturated C═C double bond-containing polyphenylene ether resin includes an unsaturated C═C double bond-containing polyphenylene ether resin with 2,6-dimethyl substitution in its phenylene ether backbone, wherein the methyl groups form steric hindrance to prevent the oxygen atom of the ether group from forming a hydrogen bond or Van der Waals force to absorb moisture, thereby having a lower dielectric property.

In some exemplary embodiments, the unsaturated C═C double bond-containing polyphenylene ether resin includes a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-containing polyphenylene ether resin with a number average molecular weight of about 2400 to 2800 (such as vinylbenzyl group-containing bisphenol A polyphenylene ether resin), a (meth)acryloyl group-containing polyphenylene ether resin with a number average molecular weight of about 1900 to 2300 (such as SA9000, available from Sabic), a vinyl group-containing polyphenylene ether resin with a number average molecular weight of about 2200 to 3000, or a combination thereof, but the present disclosure is not limited thereto. Among them, the vinyl group-containing polyphenylene ether resin may include various polyphenylene ether resins disclosed in US Patent Application Publication No. 20160185904 A1, all of which are incorporated herein by reference in their entirety. Among them, the vinylbenzyl group-containing polyphenylene ether resin includes a vinylbenzyl group-containing biphenyl polyphenylene ether resin, a vinylbenzyl group-containing bisphenol A polyphenylene ether resin, or a combination thereof, but the present disclosure is not limited thereto.

The phosphorus content in the phosphorus-containing polyolefin resin is 3 to 10 wt %, preferably, the phosphorus content in the phosphorus-containing polyolefin resin is 3.1 to 4.0 wt %. An article made from a resin composition comprising the phosphorus-containing polyolefin resin with the phosphorus content within a range from 3 to 10 wt % and the unsaturated C═C double bond-containing polyphenylene ether resin has excellent performances, such as excellent stickiness resistance, high flame retardancy, excellent alkali resistance and excellent thermal resistance after moisture absorption, high glass transition temperature and high copper foil peeling strength, low dielectric constant and dissipation factor and low water absorption rate, preferable laminate appearance, etc. Further, when the content of the phosphorus-containing polyolefin resin is preferably 3.1 to 4.0 wt %, each of the performance described above is significantly improved, particularly having a lower water absorption rate and a better alkali resistance.

The phosphorus-containing polyolefin resin comprises any one of a phosphorus-containing polyolefin resin represented by Formula (1), a phosphorus-containing polyolefin resin represented by Formula (2), a phosphorus-containing polyolefin resin represented by Formula (3), a phosphorus-containing polyolefin resin represented by Formula (4), a phosphorus-containing polyolefin resin represented by Formula (5), a phosphorus-containing polyolefin resin represented by Formula (6), a phosphorus-containing polyolefin resin represented by Formula (7), a phosphorus-containing polyolefin resin represented by Formula (8), or a combination thereof.

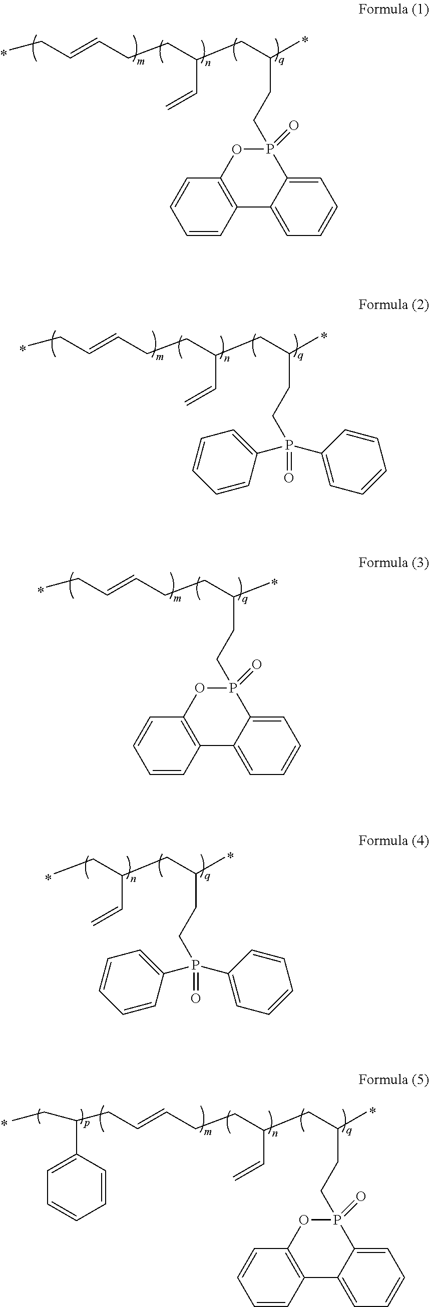

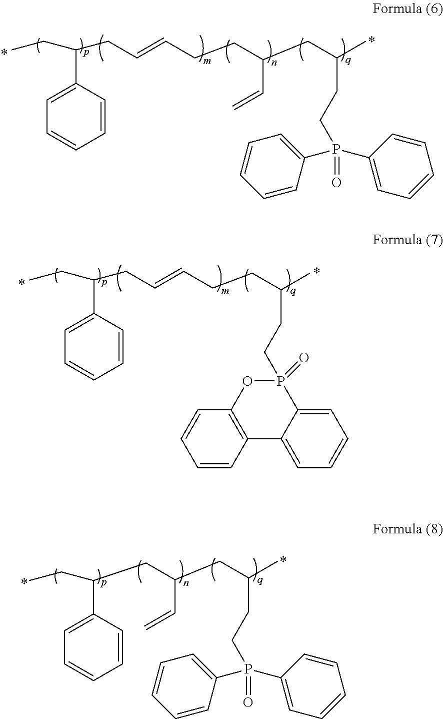

Wherein, in Formula (1) to Formula (8) (symbol “*” represents a bonding position between the structural units), each of p, m, n, or q is independent, wherein p is an integer of 1 to 200, m is an integer of 2 to 200, n is an integer of 10 to 400, q is an integer of 1 to 100, preferably, each of p, m, n, or q is independent, wherein p is an integer of 1 to 100, m is an integer of 2 to 100, n is an integer of 10 to 200, q is an integer of 1 to 50, more preferably, each of p, m, n, or q is independent, wherein p is an integer of 1 to 40, m is an integer of 2 to 30, n is an integer of 10 to 80, q is an integer of 1 to 30. Each of p, m, n, or q in Formula (1) to Formula (8) may be the same or different, and each of p, m, n, or q, such as p=1, 2, 3, 4, 5, 6, 7, 8, 9, 10, 11, 12, 13, 14, 15, 16, 17, 18, 19, 20, 40, 60, 80, 100, or 200; m=2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 60, 80, 100, or 200; n=10, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 100, 200, 300, or 400; q=1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 60, 80, or 100, but the present disclosure is not limited thereto.

The Formula (1) to Formula (8) described above only exemplify that the phosphorus-containing polyolefin resin has m, n, q, p structural units, and do not limit the specific bonding order of each structural unit. That is, each structural unit may be bonded in various forms, including random bonding, alternating bonding, or block bonding, but the present disclosure is not limited thereto.

For instance, when the phosphorus-containing polyolefin resin contains more than two structural units, the bonding order of each structural unit is not particularly limited, for instance, it may be random bonding (such as a structure of -abbbaaabba-), alternating bonding (such as a structure of -abababab-), or block bonding (such as a structure of -aaaaa-bbbbbb-aaaaa-). For instance, when the phosphorus-containing polyolefin resin contains three structural units of a1, a2, and b1, it is represented by the structural formula -a1a2b1- (such as Formula (1)). This only exemplify that the phosphorus-containing polyolefin resin contains three structural units of a1, a2, and b1, and does not mean to limit the bonding order of three structural units, i.e. structural formula -a1a2b1-. It includes a phosphorus-containing polyolefin resin comprising three structural units of a1, a2, and b1 which are random bonded, a phosphorus-containing polyolefin resin comprising three structural units of a1, a2, and b1 which are alternating bonded, a phosphorus-containing polyolefin resin comprising three structural units of a1, a2, and b1 which are block bonded, or a combination thereof, but the present disclosure is not limited thereto. For another example, when the phosphorus-containing polyolefin resin contains four structural units of c, a1, a2, and b1, it is represented by the structural formula -ca1a2b1- (such as Formula (5)). This only exemplify that the phosphorus-containing polyolefin resin contains four structural units of c, a1, a2, and b1, and does not mean to limit the bonding order of four structural units. That is, the structural formula -ca1a2b1- includes a phosphorus-containing polyolefin resin comprising four structural units of c, a1, a2, and b1 which are random bonded, a phosphorus-containing polyolefin resin comprising four structural units of c, a1, a2, and b1 which are alternating bonded, a phosphorus-containing polyolefin resin comprising four structural units of c, a1, a2, and b1 which are block bonded, or a combination thereof, but the present disclosure is not limited thereto.

The phosphorus-containing polyolefin resin may be prepared by various methods known by the person ordinarily skilled in the art. For instance, the preparation method of the phosphorus-containing polyolefin resin comprises following steps:

Polybutadiene-based resins and phosphorus-containing compounds are added into a three-necked flask, and react under high-speed stirring at 130 to 160° C. for 3 to 10 hours with N₂ protection, then the polybutadiene-based resin and the phosphorus-containing compound undergo an addition reaction to generate a phosphorus-containing polyolefin resin.

For instance, the polybutadiene-based resin may comprise polybutadiene, butadiene-styrene copolymer. The polybutadiene-based resin may be such as: a styrene-butadiene random copolymer (such as Ricon100, Ricon181, Ricon184, or a combination thereof available from Cray vally), or a polybutadiene (such as B-1000, B-2000, B-3000, or a combination thereof available from Nippon Soda), or styrene-butadiene block copolymer (such as SBS-C, SBS-A, or a combination thereof available from Nippon Soda), but the present disclosure is not limited thereto.

For instance, the phosphorus-containing compound comprises 9,10-dihydro-9-oxa-10-phosphaphenanthrene-10-oxide (DOPO) and its derivatives or resins, diphenylphosphine oxide (DPPO) and its derivatives or resins, or a combination thereof.

For instance, in one exemplary embodiment, the molar ratio of the amount of the polybutadiene-based resin to the phosphorus-containing compound is 1:2 to 1:18, preferably, the molar ratio of the amount of the polybutadiene-based resin to the phosphorus-containing compound is 1:2 to 1:8.

For instance, in one exemplary embodiment, the aforesaid resin composition may also further comprise an unsaturated C═C double bond-containing crosslinking agent. The unsaturated C═C double bond-containing crosslinking agent applicable to the present disclosure refers to an unsaturated C═C double bond-containing small molecule compound with a molecular weight less than or equal to 1000, preferably between 100 and 900, more preferably between 100 and 800. For instance, in one exemplary embodiment, compared to 100 parts by weight of the unsaturated C═C double bond-containing polyphenylene ether resin, the amount of the unsaturated C═C double bond-containing crosslinking agent of the present disclosure may be 1 part by weight to 50 parts by weight, preferably 1 part by weight to 10 parts by weight of the unsaturated C═C double bond-containing crosslinking agent, but it is not limited thereto.

For instance, the unsaturated C═C double bond-containing crosslinking agent may be bis(vinylphenyl)ethane (BVPE), bis(vinylbenzyl) ether, divinylbenzene (DVB), divinylnaphthalene, divinylbiphenyl, triallyl isocyanurate (TAIC), triallyl cyanurate (TAC), trivinyl cyclohexane (TVCH), diallyl bisphenol A (DABPA), butadiene, decadiene, octadiene, acrylate having two or more functional groups (multifunctional acrylates), or a combination thereof, but the present disclosure is not limited thereto.

The multifunctional acrylates comprise various bifunctional acrylates, trifunctional acrylates, or tetrafunctional or higher acrylates commonly known in the field, available from Shin-Nakamura Chemical Industry Co., Ltd., Kyoeisha Chemical Co., Ltd., Nippon Kayaku Co., Ltd., or Sartomer. Specific examples of multifunctional acrylates include any one of a diallyl isophthalate (DAIP), a dioxane glycol diacrylate, a tricyclodecane dimethanol diacrylate, a tricyclodecane dimethanol dimethacrylate, or a combination thereof, but the present disclosure is not limited thereto.

For instance, in one exemplary embodiment, the resin composition of the present disclosure may also further comprise a phosphorus-free polyolefin. For instance, in one exemplary embodiment, compared to 100 parts by weight of the unsaturated C═C double bond-containing polyphenylene ether resin, the amount of the phosphorus-free polyolefin of the present disclosure may be 1 part by weight to 50 parts by weight, preferably 1 part by weight to 10 parts by weight of the phosphorus-free polyolefin, but it is not limited thereto. The phosphorus-free polyolefin applicable to the present disclosure is not particularly limited, and may be any one or more of polyolefin applicable to the production of a prepreg, a resin film, a laminate, or a printed circuit board, and may be any one or more of commercial products, self-prepared products or a combination thereof. For instance, the phosphorus-free polyolefin applicable to the present disclosure includes a diene polymer, a monoene polymer, a hydrogenated diene polymer, or a combination thereof, but the present disclosure is not limited thereto. The term “diene” refers to a hydrocarbon compound with two unsaturated C═C double bonds. The term “monoene” refers to a hydrocarbon compound with one unsaturated C═C double bonds. The phosphorus-free polyolefin applicable to the present disclosure includes such as any one of polybutadiene, polyisoprene, styrene-butadiene copolymer, styrene-isoprene copolymer, styrene-butadiene-divinylbenzene terpolymer, polybutadiene-styrene copolymer adducted with maleic anhydride, vinyl-polybutadiene-urethane polymer, polybutadiene adducted with maleic anhydride, polymethylstyrene, hydrogenated polybutadiene, hydrogenated polyisoprene, hydrogenated styrene-butadiene-divinylbenzene terpolymer, hydrogenated styrene-butadiene copolymer adducted with maleic anhydride, hydrogenated styrene-butadiene copolymer, hydrogenated styrene-isoprene copolymer, epoxy-containing polybutadiene, and polyfunctional vinyl aromatic copolymer, or a combination thereof, but the present disclosure is not limited thereto.

The polyfunctional vinyl aromatic copolymer in the resin composition of the present disclosure may include various polyfunctional vinyl aromatic copolymers disclosed in US Patent Application Publication No. 20070129502 A1, all of which are incorporated herein by reference in their entirety.

For instance, in one exemplary embodiment, any one of a maleimide resin, a benzoxazine resin, an epoxy resin, an organic silicone resin, a cyanate ester resin, an active ester, a phenol resin, an amine curing agent, a styrene maleic anhydride, a polyamide, a polyimide, or a combination thereof may also be added into the resin composition of the present disclosure as needed.

In the resin composition of the present disclosure, with respect to 100 parts by weight of the unsaturated C═C double bond-containing polyphenylene ether resin, the amount of maleimide resin, benzoxazine resin, epoxy resin, organic silicone resin, cyanate ester resin, polyester resin, phenol resin, styrene maleic anhydride, polyamide, and polyimide is not particularly limited. For instance, each of the component may independently range from 1 part by weight to 100 parts by weight, such as 1 part by weight, 10 parts by weight, 15 parts by weight, 20 parts by weight, 25 parts by weight, 50 parts by weight, or 100 parts by weight, but the present disclosure is not limited thereto. With respect to 100 parts by weight of the unsaturated C═C double bond-containing polyphenylene ether resin, the amount of the amine curing agent is not particularly limited either. For instance, the amount of the amine curing agent may be 1 to 15 parts by weight, such as 1 part by weight, 4 parts by weight, 7.5 parts by weight, 12 parts by weight, or 15 parts by weight, but the present disclosure is not limited thereto.

The maleimide resin applicable to the resin composition of the present disclosure is not particularly limited, and may be any one or more of maleimide resins applicable to the production of a prepreg, a resin film, a laminate, or a printed circuit board. In some exemplary embodiments, the maleimide resin may be such as: 4,4′-diphenylmethane bismaleimide, polyphenylmethane maleimide (or oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide (VBM), biphenyl-containing maleimide, maleimide resin containing an aliphatic structure with 10 to 50 carbon atoms, indane-containing maleimide, m-arylene-containing maleimide, diallyl compound-modified maleimide resin, diamino-modified maleimide resin, multifunctional amino-modified maleimide resin, acidic phenol compound-modified maleimide resin, cyanate ester-modified maleimide resin, or a combination thereof, but the present disclosure is not limited thereto. The maleimide resin is also includes the modification of these components, wherein m-arylene-containing maleimide refers to product MIR-5000, available from Nippon Kayaku.

For instance, the maleimide resin may include products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H available from Daiwakasei Industry Co., Ltd., BMI-70, and BMI-80 available from K.I Chemical Industry Co., Ltd., or MIR-3000 and MIR-5000 available from Nippon Kayaku, but the present disclosure is not limited thereto.

For instance, the maleimide resin containing the aliphatic structure with 10 to 50 carbon atoms (also known as imide-extended maleimide resin) may include various imide-extended maleimide resins disclosed in TW Patent Application Publication No. 200508284A, all of which are incorporated herein by reference in their entirety. The maleimide resin containing the aliphatic structure with 10 to 50 carbon atoms applicable to the present disclosure may include products such as BMI-689, BMI-1400, BMI-1500, BMI-1700, BMI-2500, BMI-3000, BMI-5000 and BMI-6000 available from Designer Molecules Inc., but the present disclosure is not limited thereto.

The benzoxazine resin may be various benzoxazine resins known in the field. Specific examples of the benzoxazine resin include bisphenol A benzoxazine resin, bisphenol F benzoxazine resin, phenolphthalein benzoxazine resin, dicyclopentadiene benzoxazine resin, phosphorus-containing benzoxazine resin, diaminobenzoxazine resin, and phenyl, vinyl or allyl-modified benzoxazine resin, but the present disclosure is not limited thereto. Commercially available products include LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, or KZH-5031 (vinyl-modified benzoxazine resin) and KZH-5032 (phenyl-modified benzoxazine resin) available from Kolon Industries Inc. Among them, the diaminobenzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin, or a combination thereof, but the present disclosure is not limited thereto.

The epoxy resin may be various epoxy resins known in the field. In terms of improving the thermal resistance of the resin composition, the epoxy resin described above includes such as bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (such as naphthol epoxy resin), benzofuran epoxy resin, isocyanate-modified epoxy resin, or a combination thereof, but the present disclosure is not limited thereto. Among them, the novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. Among them, the phosphorus-containing epoxy resin may be DOPO (9,10-dihydro-9-oxa-10-phosphaphenanthrene-10-oxide) epoxy resin, DOPO-HQ epoxy resin, or a combination thereof. The DOPO epoxy resin may be selected from one or more of DOPO-containing phenol novolac epoxy resin, DOPO-containing o-cresol novolac epoxy resin and DOPO-containing bisphenol-A novolac epoxy resin. The DOPO-HQ epoxy resin may be selected from one or more of DOPO-HQ-containing phenol novolac epoxy resin, DOPO-HQ-containing o-cresol novolac epoxy resin and DOPO-HQ-containing bisphenol-A novolac epoxy resin, but the present disclosure is not limited thereto.

The organic silicone resin may be various organic silicone resins known in the field. Specific examples of the organic silicone resin include a polyalkylsiloxane resin, a polyarylsiloxane resin, a polyalkarylsiloxane resin, a modified polysiloxane resin, or a combination thereof, but the present disclosure is not limited thereto. Preferably, an amino-modified silicone resin is applicable to the organic silicone resin in the resin composition of the present disclosure, such as products KF-8010, X-22-161A, X-22-161B, KF-8012, KF-8008, X-22-9409, and X-22-1660B-3 available from Shin-Etsu Chemical Co., Ltd., products BY-16-853U, BY-16-853, and BY-16-853B available from Toray-Dow coming Co., Ltd., and products XF42-C5742, XF42-C6252, and XF42-C5379 available from Momentive Performance Materials JAPAN LLC, or a combination thereof, but the present disclosure is not limited thereto.

The cyanate ester resin may be any one or more of cyanate ester resin applicable to the production of a prepreg, a resin film, a laminate, or a printed circuit board. The cyanate ester resin may be a compound having Ar—O—C≡N structure, wherein Ar may be a substituted or unsubstituted aromatic group. In terms of improving the thermal resistance of the resin composition, the specific example of the cyanate ester resin includes novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin, or a combination thereof, but the present disclosure is not limited thereto. Among them, the novolac cyanate ester resin may be bisphenol A novolac cyanate ester resin, bisphenol F novolac cyanate ester resin or a combination thereof. For instance, the cyanate ester resin may be products such as Primaset PT-15, PT-30S, PT-60S, BA-200, BA-230S, BA-3000S, BTP-2500, BTP-6020S, DT-4000, DT-7000, ULL950S, HTL-300, CE-320, LVT-50, and LeCy available from Lonza.

The active ester applicable to the resin composition of the present disclosure may be various active polyester resins known in the field, including various commercial active polyester resins, but the present disclosure is not limited thereto. Specific examples of the active esters include dicyclopentadiene-containing polyester resin, and naphthalene-containing polyester resin, such as products HPC-8000 and HPC-8150 available from Dainippon Ink & Chemicals, but the present disclosure is not limited thereto.

The phenol resin may be various phenol resins known in the field. Specific examples of the phenol resin include novolac resin or phenoxy resin, but the present disclosure is not limited thereto. Among them, the novolac resin includes phenol novolac resin, o-cresol novolac resin, bisphenol-A novolac resin, naphthol novolac resin, biphenyl novolac resin and dicyclopentadiene phenol resin, but the present disclosure is not limited thereto.

The amine curing agent may be various amine curing agents known in the field. Specific examples of the amine curing agent include at least one of diaminodiphenyl sulfone, diaminodiphenyl methane, diaminodiphenyl ether, diaminodiphenyl sulfide and dicyandiamide, or a combination thereof, but the present disclosure is not limited thereto.

The styrene maleic anhydride may be various styrene maleic anhydrides known in the field, wherein the ratio of the styrene (St) and maleic anhydride (MA) may be 1/1, 2/1, 3/1, 4/1, 6/1, 8/1 or 12/1. Specific examples of the styrene maleic anhydride include styrene maleic anhydride copolymers, such as SMA-1000, SMA-2000, SMA-3000, EF-30, EF-40, EF-60 and EF-80 available from Cray Valley, or styrene maleic anhydride copolymer, such as C400, C500, C700, and C900 available from Polyscope, but the present disclosure is not limited thereto.

The polyamide may be various polyamides known in the field, including various commercially available polyamide resin products, but the present disclosure is not limited thereto.

The polyimide may be various polyimides known in the field, including various commercially available polyimide resin products, but the present disclosure is not limited thereto.

Besides the aforesaid components, the resin composition of the present disclosure may also further include a flame retardant, a curing accelerator, a polymerization inhibitor, an inorganic filler, solvent, a silane coupling agent, a surfactant, a coloring agent, a toughening agent, or a combination thereof.

For instance, the inorganic filler applicable to the present disclosure may be any one or more of the inorganic fillers applicable to the production of a prepreg, a resin film, a laminate, or a printed circuit board. Specific examples of the inorganic filler include silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaolin, or a combination thereof, but the present disclosure is not limited thereto. Moreover, the inorganic filler may be spherical (including solid sphere-shaped or hollow-shaped), fibrous, plate, particulate, flake or whisker and may be optionally pretreated by a silane coupling agent. For instance, in one exemplary embodiment, the resin composition of the present disclosure may also further include 10 parts by weight to 300 parts by weight of the inorganic filler, preferably 100 parts by weight to 250 parts by weight of the inorganic filler, but the present disclosure is not limited thereto, with respect to 100 parts by weight of the unsaturated C═C double bond-containing polyphenylene ether resin.

For instance, the flame retardant applicable to the present disclosure may be any one or more of flame retardants applicable to the production of a prepreg, a resin film, a laminate, or a printed circuit board, such as bromine-containing flame retardant or phosphorus-containing flame retardant, but the present disclosure is not limited thereto. The bromine-containing flame retardant preferably comprises decabromodiphenyl ethane, and the phosphorus-containing flame retardant preferably comprises: ammonium polyphosphate, p-hydroquinone bis(diphenyl phosphate), bisphenol A bis(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, 9,10-dihydro-9-oxa-10-phosphaphenanthrene-10-oxide (DOPO) and its derivatives or resins, diphenylphosphine oxide (DPPO) and its derivatives or resins, melamine cyanurate and tri-hydroxy ethyl isocyanurate, aluminium phosphinate (such as commercially available OP-930 and OP-935), or a combination thereof.

For instance, a DPPO compound may be a di-DPPO compound. A DOPO compound may be a di-DOPO compound, a DOPO-HQ, a DOPO-NQ, or a vinyl group-containing DOPO compound. A DOPO resin may be a DOPO-bonded novolac resin or a DOPO-bonded epoxy resin, etc., wherein the DOPO-bonded novolac resin includes a bisphenol novolac resin, such as DOPO phenol novolac (DOPO-PN), DOPO-bisphenol A novolac (DOPO-BPAN), DOPO-bisphenol F novolac (DOPO-BPFN), DOPO-bisphenol S novolac (DOPO-BPSN), etc., but the present disclosure is not limited thereto

Preferably, the flame retardant is a DOPO compound and its derivatives or resins, DPPO compound and its derivatives or resins, or a combination thereof.

Compared to 100 parts by weight of the unsaturated C═C double bond-containing polyphenylene ether resin, the amount of the flame retardant described above may be 1 part by weight to 65 parts by weight. Preferably, the amount of the flame retardant may be 1 part by weight to 10 parts by weight.

The curing accelerator (including curing initiator) applicable to the present disclosure may include a catalyst, such as a Lewis base or a Lewis acid. The Lewis base may include one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may include metal salt compounds, such as metal salt compounds of manganese, iron, cobalt, nickel, copper and zinc, and metal catalysts, such as zinc octanoate or cobalt octanoate. The curing accelerator also includes a curing initiator, such as a peroxide capable of producing free radicals. The curing initiator includes dicumyl peroxide, t-butyl peroxybenzoate, dibenzoyl peroxide (BPO), 2,5-dimethyl-2,5-di(t-butylperoxy)-3-hexyne (25B), bis(t-butylperoxyisopropyl)benzene, or a combination thereof, but the present disclosure is not limited thereto.

For instance, in one exemplary embodiment, compared to 100 parts by weight of the unsaturated C═C double bond-containing polyphenylene ether resin, the resin composition of the present disclosure may also further include 0.1 parts by weight to 5 parts by weight of the curing accelerator, preferably 0.5 parts by weight to 3 parts by weight of the curing accelerator, but the present disclosure is not limited thereto.

For instance, the polymerization inhibitor applicable to the present disclosure may include 1,1-diphenyl-2-picrylhydrazyl, methyl acrylonitrile, nitroxide-mediated radical, triphenylmethyl radical, metal ion radical, sulfur radical (such as dithioester, but the present disclosure is not limited thereto), hydroquinone, 4-methoxyphenol, p-benzoquinone, phenothiazine, 0-phenylnaphthylamine, 4-t-butylcatechol, methylene blue, 4,4′-butylidenebis(6-t-butyl-3-methylphenol), 2,2′-methylenebis(4-ethyl-6-t-butyl phenol), or a combination thereof, but the present disclosure is not limited thereto. For instance, the nitroxide-mediated radical described above may include nitroxide radicals derived from cyclic hydroxylamines, such as 2,2,6,6-tetramethylpiperidine-1-oxyl, 2,2,6,6-substituted piperidine-1-oxyl free radical, or 2,2,5,5-substituted pyrrolidine-1-oxyl free radical, or the like, but the present disclosure is not limited thereto. Substitutes preferably include alkyl groups with 4 or fewer carbon atoms, such as methyl group or ethyl group. The specific nitroxide radical compound is not limited, and examples include 2,2,6,6-tetramethylpiperidine-1-oxyl free radical, 2,2,6,6-tetraethylpiperidine-1-oxyl free radical, 2,2,6,6-tetramethyl-4-oxo-piperidine-1-oxyl free radical, 2,2,5,5-tetramethylpyrrolidine-1-oxyl free radical, 1,1,3,3-tetramethyl-2-isoindoline oxygen radical, N,N-di-tert-butylamine oxygen free radical or the like, but the present disclosure is not limited thereto. The nitroxide radicals may also be replaced by stable radicals such as galvinoxyl radicals. The polymerization inhibitor applicable to the resin composition of the present disclosure may also be products derived from the polymerization inhibitor with its hydrogen atom or atomic group substituted by other atom or atomic group, such as products derived from the polymerization inhibitor with its hydrogen atom substituted by an amino group, a hydroxyl group, a carbonyl group or the like.

For instance, in one exemplary embodiment, compared to 100 parts by weight of the unsaturated C═C double bond-containing polyphenylene ether resin, the resin composition of the present disclosure may also further include 0.001 parts by weight to 20 parts by weight of the polymerization inhibitor, preferably 0.001 parts by weight to 10 parts by weight of the polymerization inhibitor, but the present disclosure is not limited thereto.

For instance, the solvent applicable to the resin composition of the present disclosure is not particularly limited, and may be any solvent applicable to dissolving the resin composition of the present disclosure, including: methanol, ethanol, ethylene glycol monomethyl ether, acetone, butanone (i.e. methyl ethyl ketone), methyl isobutyl ketone, cyclohexanone, N-methylpyrrolidone, toluene, xylene, methoxyethyl acetate, ethoxyethyl acetate, propoxyethyl acetate, ethyl acetate, dimethyl formamide, dimethyl acetamide, propylene glycol monomethyl ether acetate or a mixture thereof, but the present disclosure is not limited thereto. The additive amount of the solvent is for the purpose of being able to completely dissolve the resin and being adjusted to the specific solid content of the resin composition. For instance, in one exemplary embodiment, the solvent is added at an additive amount to adjust the solid content of the resin composition to 50% to 85%, but the present disclosure is not limited thereto.

For instance, the silane coupling agent described above may comprise silane (such as siloxane, but the present disclosure is not limited thereto), which may be further categorized according to the functional groups into amino silane, epoxide silane, vinyl silane, hydroxyl silane, isocyanate silane, methacryloxy silane and acryloxy silane.

For instance, in one exemplary embodiment, compared to 100 parts by weight of the unsaturated C═C double bond-containing polyphenylene ether resin, the resin composition of the present disclosure may also further comprises 0.001 parts by weight to 20 parts by weight of silane coupling agent, preferably 0.01 parts by weight to 10 parts by weight of silane coupling agent, but the present disclosure is not limited thereto.

The type of the surfactant applicable to the resin composition of the present disclosure is not particularly limited. The purpose of adding surfactant is to make the filler uniformly distributed in resin composition.

For instance, the coloring agent described above may include dye or pigment, but the present disclosure is not limited thereto.

The purpose of adding toughening agent is to improve the toughness of the resin composition. For instance, the toughening agent described above may include carboxyl-terminated butadiene acrylonitrile rubber (CTBN), core-shell rubber, ethylene propylene rubber, or a combination thereof, but the present disclosure is not limited thereto. For instance, in one exemplary embodiment, compared to 100 parts by weight of the unsaturated C═C double bond-containing polyphenylene ether resin, the resin composition of the present disclosure may also further comprise 1 part by weight to 20 parts by weight of toughening agent, preferably 3 parts by weight to 10 parts by weight of toughening agent, but the present disclosure is not limited thereto.

The resin composition of each exemplary embodiment may be made into various articles, such as components applicable to various electronic products, including a prepreg, a resin film, a laminate, or a printed circuit board, but the present disclosure is not limited thereto.

For instance, the resin composition of each exemplary embodiment of the present disclosure may be made into a prepreg, which includes a reinforcement material and a layered structure disposed thereon. The layered structure is obtained by heating the resin composition at high temperature to a semi-cured state (B-stage). The baking temperature for making the prepreg is between 120° C. and 180° C., preferably between 120° C. and 160° C. The reinforcement material may be any one of fiber material, woven fabric, and non-woven fabric, and the woven fabric preferably includes fiberglass fabrics. Types of fiberglass fabrics are not particularly limited and may be any fiberglass fabrics for printed circuit boards, such as E-glass fiber fabric, D-glass fiber fabric, S-glass fiber fabric, T-glass fiber fabric, L-glass fiber fabric, Q-glass fiber fabric or QL-glass fiber fabric (a glass fiber fabric with a mixed structure made from Q-glass fiber fabric and L-glass fiber fabric). Types of fiberglass include yarns and rovings, in spread form or standard form. The shape of the end surface includes a circular or flat shape. The non-woven fabric preferably includes liquid crystal resin non-woven fabric, such as polyester non-woven fabric, polyurethane non-woven fabric or the like, and not limited thereto. The woven fabric may also include liquid crystal resin woven fabric, such as polyester woven fabric or polyurethane woven fabric or the like, and not limited thereto. The reinforcement materials may increase the mechanical strength of the prepreg. In one preferable exemplary embodiment, the reinforcement materials may be optionally pretreated by a silane coupling agent. The prepreg may be further heated and cured to the C-stage to form an insulation layer.

For instance, the resin composition of each exemplary embodiment of the present disclosure may be made into a resin film, which is obtained by heating and baking the resin composition to a semi-cured state. The resin composition may be optionally coated on a liquid crystal polymer film, a polytetrafluoroethylene film, a polyethylene terephthalate film (PET film), a polyimide film (PI film), a copper foil or a resin-coated copper foil, followed by heating and baking to a semi-cured state so as to make the resin composition form into a resin film.

For instance, the resin composition of the present disclosure may be made into various laminates, including at least two metal foils and at least one insulation layer disposed between the two metal foils. The insulation layer may be obtained by curing the resin composition at high temperature and high pressure to the C-stage. The suitable curing temperature is, for instance, between 190° C. and 220° C., preferably between 200° C. and 210° C., and the curing time is 90 to 180 minutes, preferably 120 to 150 minutes. The suitable lamination pressure is, for instance, between 300 psi and 550 psi, preferably between 400 psi and 500 psi. The insulation layer may be obtained by curing the prepreg or resin film. The material of the metal foil may be copper, aluminum, nickel, platinum, silver, gold or alloy thereof, such as a copper foil. In a preferable embodiment, the laminate is a copper-clad laminate.

In one exemplary embodiment, the laminate may be further processed by circuit processing to obtain a printed circuit board.

One of the production method of the printed circuit board of the present disclosure may be as the following. A double-sided copper-clad laminate (such as product EM-827, available from Elite Material Co., Ltd.) with a thickness of 28 mil and having a 1 ounce HTE (High Temperature Elongation) copper foil may be provided and subject to drilling and electroplating so as to form electrical conduction between the top layer copper foil and the bottom layer copper foil. Then the top layer copper foil and the bottom layer copper foil are etched to form an inner layer circuit board. Then brown oxidation and roughening are performed on the inner layer circuit board to form uneven structures on the surface to increase roughness. Next, a copper foil, the prepreg, the inner layer circuit board, the prepreg, and a copper foil are sequentially stacked and then heated at 190° C. to 220° C. for 90 to 180 minutes by a vacuum lamination apparatus to cure the insulation layer material of the prepreg. Next, black oxidation, drilling, copper plating and other circuit board processes known in the field are performed on the outmost copper foil to obtain the printed circuit board.

In one or more exemplary embodiments, various articles made from the resin composition of the present disclosure may preferably have at least one of the following properties:
in one exemplary embodiment, after vacuum-packed, neither stickiness nor powder falling occur in the prepreg after it has been placed at 40° C. for 2 hours,
a dielectric constant at 10 GHz as measured by reference to JISC2565 of less than or equal to 3.30, such as between 3.15 and 3.30,
a dissipation factor at 10 GHz as measured by reference to JISC2565 of less than or equal to 0.0030, such as between 0.0026 and 0.0030,
a glass transition temperature as measured by reference to IPC-TM-650 2.4.24.4 of greater than or equal to 200° C., such as between 200° C. and 217° C.,
a flame retardancy as measured by reference to UL94 rating of V0,
no delamination occurs after subjecting the article to a thermal resistance after moisture absorption test by reference to IPC-TM-650 2.6.16.1 and IPC-TM-650 2.4.23,
a water absorption rate as measured by reference to IPC-TM-650 2.6.2.1 and IPC-TM-650 2.6.16.1 of less than or equal to 0.30%, such as between 0.17% and 0.30%,
a copper foil peeling strength as measured by reference to IPC-TM-650 2.4.8 of greater than or equal to 3.1 lb/in, such as between 3.1 lb/in and 3.8 lb/in,
an alkali resistance of a laminate as measured by an alkali resistance test of greater than or equal to 10 minutes, such as between 10 minutes and 20 minutes,
by visual inspection with naked eyes, it is observed that neither patterns nor yellow spots are on the laminate appearance.

The property tests of the examples and comparative examples are performed by samples (specimens) prepared as described below, and are tested under specific conditions.

### 1. Prepreg:

The resin compositions respectively selected from the examples or comparative examples are mixed uniformly to form varnish. The varnish is loaded into an impregnation tank, and the fiberglass fabric (such as 2116 L-glass fiber fabric or 1080 L-glass fiber fabric, all available from Asahi) is then immersed into the impregnation tank described above to adhere the resin composition onto the fiberglass fabric, followed by heating at 150° C. to 170° C. to a semi-cured stage (B-Stage) to obtain a prepreg with a resin content of about 53%.

### 2. Copper-Clad Laminate (8-Ply, Formed by Lamination of Eight Prepregs):

Two HVLP copper foils with a thickness of 18 μm and eight prepregs, with a resin content of about 53% for each, obtained from 2116 L-glass fiber fabrics impregnated with each specimen (each example or comparative example) are prepared and stacked in the order of one HVLP copper foil, eight prepregs and one HVLP copper foil, followed by lamination under vacuum at 500 psi and 200° C. for 2 hours to form a copper-clad laminate. The eight prepregs stacked with each other are cured and formed into an insulation layer between the two copper foils, and the insulation layer has a resin content of about 53%.

### 3. Copper-Free Laminate (8-Ply, Formed by Lamination of Eight Prepregs):

The copper-clad laminate (8-ply) described above is etched to remove two copper foils to obtain a copper-free laminate (8-ply) which is formed by laminating eight prepregs and has a resin content of about 53%.

### 4. Copper-Free Laminate (2-Ply, Formed by Lamination of Two Prepregs):

Two HVLP copper foils with a thickness of 18 μm and two prepregs obtained from 1080 L-glass fiber fabrics impregnated with each specimen (each example or comparative example) are prepared and stacked in the order of one copper foil, two prepregs and one copper foil, followed by lamination under vacuum at 500 psi and 200° C. for 2 hours to form a copper-clad laminate (2-ply, formed by lamination of two prepregs). Next, the copper-clad laminate (2-ply) described above is etched to remove the copper foils on both sides to obtain a copper-free laminate (2-ply), which is formed by laminating two prepregs and has a resin content of about 80%.

For the aforesaid specimens, each testing method and the properties are described below.

### 1. Prepreg Stickiness Resistance

The prepregs obtained from 2116 L-glass fiber fabrics impregnated with each specimen (each example or comparative example) are selected, vacuum-packed by aluminium foil bag, and placed at 40° C. for 2 hours, and then the prepregs are removed for inspection of whether stickiness and powder falling occur on the surface between the prepreg and another adjacent prepreg. Absence of stickiness and powder falling on the surface of the prepreg is designated as “OK,” while presence of stickiness or powder falling on the surface of the prepreg is designated as “stickiness or powder falling.” Presence of stickiness or powder falling on the surface of the prepreg indicates poor operability of the prepreg.

### 2. Glass Transition Temperature (Tg)

The copper-free laminate (8-ply) is selected as a specimen. A dynamic mechanical analyzer (DMA) is used by reference to IPC-TM-650 2.4.24.4 (2012) to measure the glass transition temperature (in ° C.) of each specimen. Temperature interval during the measurement is set at 50 to 400° C. with a temperature increasing rate of 2° C./minute.

### 3. Dielectric Constant (Dk) and Dissipation Factor (Df)

The copper-free laminate (2-ply) is selected as a specimen. A microwave dielectrometer available from AET Corp. is used by reference to JISC2565(1992) to measure each specimen at 10 GHz at room temperature (about 25° C.). Lower dielectric constant and dissipation factor represent better dielectric properties of the specimen. At a frequency of 10 GHz, for a Df value of less than 0.005, a difference in Df value of greater than or equal to 0.0001 represents a significant difference between dissipation factors of different laminates (i.e. significant technical difficulty is present).

### 4. Flame Retardancy

The copper-free laminate (8-ply) (125 mm×13 mm) is selected as a specimen. The flame retardancy is measured by reference to UL94, and the results are represented by V0, V1, or V2, wherein the flame retardancy of V0 is better than the flame retardancy of V1, and the flame retardancy of V1 is better than the flame retardancy of V2. It is the worst flame retardancy when the specimen is completely burned.

5. Thermal Resistance after Moisture Absorption (Pressure Cooking Test, PCT)

The aforesaid copper-free laminate (8-ply) is selected and subject to pressure cooking by reference to IPC-TM-650 2.6.16.1 (2012) and 3 hours of moisture absorption (test temperature 121° C., relative humidity 100%), and then by reference to IPC-TM-650 2.4.23 (2012), the copper-free laminate after moisture absorption is immersed into a 288° C. solder bath for 20 seconds, and removed and inspected for the occurrence of delamination, wherein “O” represents no occurrence of delamination (no occurrence of delamination represents pass), and “X” represents occurrence of delamination (occurrence of delamination represents fail). Three specimens are tested for each Example and Comparative Example. For the three PCT tests, designation with one “X” represents that delamination occurs in one specimen, designation with two “X” represents that delamination occurs in two specimens, and designation with three “X” represents that delamination occurs in all three specimens. For instance, interlayer separation between insulation layers is considered as delamination. Interlayer separation will cause blistering and separation between any layers of the laminate.

### 6. Water Absorption Rate

The copper-free laminate (8-ply) (2 inch×2 inch) is selected as a specimen. By reference to IPC-TM-650 2.6.2.1 (2012), the copper-free laminate is placed in a 105±10° C. oven and baked for 1 hour and then cooled at room temperature (about 25° C.) for 10 minutes, and then the copper-free laminate is weighed as W₁. By reference to IPC-TM-650 2.6.16.1, the copper-free laminate then undergoes a pressure cooking test (PCT) for 3 hours of moisture absorption (test temperature at 121° C., and relative humidity 100%). After taking out and cooling the copper-free laminate, and wiping out the water on the surface of the copper-free laminate, the copper-free laminate is weighed as W₂. The water absorption rate is calculated by the following formula:

$$Water Absorption Rate ( \% ) = [ ( {W}_{2} - {W}_{1} ) / {W}_{1} ] \times 100 \%$$

### 7. Copper Foil Peeling Strength (Peeling Strength, P/S)

The aforesaid copper-clad laminate (8-ply) is cut into a rectangular specimen with a width of 24 mm and a length of greater than 60 mm, which is then etched to remove surface copper foil and leave a rectangular copper foil with a width of 3.18 mm and a length of greater than 60 mm. The specimen is tested by using a universal tensile strength tester by reference to IPC-TM-650 2.4.8 (2012) at room temperature (about 25° C.) to measure the force (lb/in) required to pull of the copper foil from the surface of laminate insulation layer.

### 8. Alkali Resistance

The copper-free laminate (8-ply) is selected as a specimen, and cut into three strips of 4 mm×2 mm specimens, placed in a 105° C. oven and baked for 2 hours, and then soaked in a 20% NaOH solution at 90° C. The specimens are removed every 5 minutes and visually inspected to determine the appearance of whitening or weave exposure, and the soaking time is recorded. The absence of whitening or weave exposure means that the specimen passes the alkali resistance test during the soaking time. The appearance of whitening or weave exposure means that the specimen fails the alkali resistance test during the soaking time. In this case, the same specimen needs to be prepared and tested again, and is removed every 1 minute and visually inspected to determine the appearance of whitening or weave exposure, and the soaking time (in minute) is recorded. The longer time means the better alkali resistance.

### 9. Laminate Appearance

The surface of the aforesaid copper-free laminate (8-ply, formed by lamination of eight prepregs) is examined by visual inspection with naked eyes to determine whether branch-like pattern (abbreviated as “pattern”) and yellow spot are present on its edge. Absence of branch-like patterns and yellow spot is designated as “OK,” while presence of branch-like patterns and yellow spot is designated as “pattern” or “yellow spot.”

The raw materials described below are used to prepare for the resin compositions of the examples and the comparative examples of the present disclosure according to the amount disclosed in Table 1 to Table 4, and are further made into various specimens.

The chemical raw materials used in the examples and the comparative examples of the present disclosure as described below:
SA9000: (meth)acryloyl group-containing polyphenylene ether resin, available from Sabic.
OPE-2st 2200: vinylbenzyl group-containing polyphenylene ether resin, available from Mitsubishi Gas Chemical Co., Inc.
OPE-2st 1200: vinylbenzyl group-containing polyphenylene ether resin, available from Mitsubishi Gas Chemical Co., Inc.
Phosphorus-containing polyolefin resins P1 to P7, prepared by Applicant and described in detail below.
D1 to D4, prepared by Applicant and described in detail below.
B-1000: polybutadiene (containing 15 wt % of 1,4-butadiene (a1) and 85 wt % of 1,2-butadiene (a2)), available from Nippon Soda.
B-3000: polybutadiene (containing 8 wt % of 1,4-butadiene (a1) and 92 wt % of 1,2-butadiene (a2)), available from Nippon Soda.
SBS-C: styrene-butadiene block copolymer, available from Nippon Soda.
Ricon 100: styrene-butadiene random copolymer, available from Cray Valley.
DPPO: diphenylphosphine oxide, available from Peking J&K Scientific Ltd.
DOPO: 9,10-dihydro-9-oxa-10-phosphaphenanthrene-10-oxide, available from Zhengzhou Alfa Chemical Co., Ltd.
Di-DOPO: di-9,10-dihydro-9-oxa-10-phosphaphenanthrene-10-oxide, having the formula below.

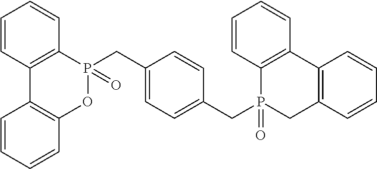 [SMILES: O=P1(Cc2ccc(CP3(=O)Oc4ccccc4-c4ccccc43)cc2)Cc2ccccc2-c2ccccc21]

Di-DPPO: di-DPPO flame retardant, having the formula below.

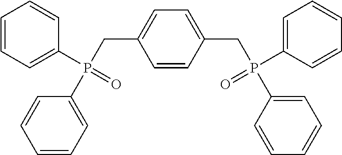 [SMILES: O=P(Cc1ccc(CP(=O)(c2ccccc2)c2ccccc2)cc1)(c1ccccc1)c1ccccc1]

BVPE: bis(vinylphenyl) ethane, available from Linchuan Chemical Co., Ltd.
Polyfunctional vinyl aromatic copolymer, commercially available.
SC-2500 SVJ: spherical silica pre-treated by silane coupling agent, available from Admatechs.
25B: 2,5-dimethyl-2,5-di(t-butylperoxy)-3-hexyne, available from NOF Corporation.
Toluene: available from Sinopec Group. The content of the toluene is indicated by “proper amount”, which represents the amount of the toluene is adjusted such that the resin composition has a solid content of 55% to 70% (solid content, S/C═55% to 70%).

### Self-Prepared Compound P1:

100 g of polybutadiene (B-1000) and 36 g of 9,10-dihydro-9-oxa-10-phosphaphenanthrene-10-oxide (DOPO) are sequentially added into a three-necked flask (the molar ratio of B-1000 to DOPO in the reaction raw materials is 1:2), and react under high-speed stirring at 130° C. for 5 hours with N₂ protection to obtain phosphorus-containing polyolefin resin with the phosphorus content of 3.8 wt % as illustrated in Formula (1), wherein m=2 to 5, n=15 to 20, q=1 to 2.

### Self-Prepared Compound P2:

100 g of polybutadiene (B-1000) and 33.7 g of diphenylphosphine oxide (DPPO) are sequentially added into a three-necked flask (the molar ratio of B-1000 to DPPO in the reaction raw materials is 1:2), and react under high-speed stirring at 140° C. for 4 hours with N₂ protection to obtain phosphorus-containing polyolefin resin with the phosphorus content of 3.9 wt % as illustrated in Formula (2), wherein m=2 to 5, n=15 to 20, q=1 to 2.

### Self-Prepared Compound P3:

100 g of polybutadiene (B-3000) and 25.3 g of diphenylphosphine oxide (DPPO) are sequentially added into a three-necked flask (the molar ratio of B-3000 to DPPO in the reaction raw materials is 1:4), and react under high-speed stirring at 145° C. for 5 hours with N₂ protection to obtain phosphorus-containing polyolefin resin with the phosphorus content of 3.1 wt % as illustrated in Formula (2), wherein m=2 to 10, n=50 to 60, q=2 to 4.

### Self-Prepared Compound P4:

100 g of styrene-butadiene block copolymer (SBS-C) and 32.3 g of diphenylphosphine oxide (DPPO) are sequentially added into a three-necked flask (the molar ratio of SBS-C to DPPO in the reaction raw materials is 1:8), and react under high-speed stirring at 150° C. for 7 hours with N₂ protection to obtain phosphorus-containing polyolefin resin with the phosphorus content of 3.7 wt % as illustrated in Formula (6), wherein m=5 to 15, n=55 to 70, q=4 to 8, p=2 to 20.

Self-Prepared Compound P5:

100 g of styrene-butadiene random copolymer (Ricon100) and 38.4 g of 9,10-dihydro-9-oxa-10-phosphaphenanthrene-10-oxide (DOPO) are sequentially added into a three-necked flask (the molar ratio of Ricon-100 to DOPO in the reaction raw materials is 1:8), and react under high-speed stirring at 150° C. for 7 hours with N₂ protection to obtain phosphorus-containing polyolefin resin with the phosphorus content of 4.0 wt % as illustrated in Formula (5), wherein m=15 to 25, n=40 to 50, q=4 to 8, p=5 to 15.

### Self-Prepared Compound P6:

100 g of polybutadiene (B3000) and 121.5 g of 9,10-dihydro-9-oxa-10-phosphaphenanthrene-10-oxide (DOPO) are sequentially added into a three-necked flask (the molar ratio of B-3000 to DOPO in the reaction raw materials is 1:18), and react under high-speed stirring at 160° C. for 10 hours with N₂ protection to obtain phosphorus-containing polyolefin resin with the phosphorus content of 7.9 wt % as illustrated in Formula (1), wherein m=2 to 10, n=35 to 50, q=10 to 18.

### Self-Prepared Compound P7:

100 g of polybutadiene (B1000) and 151.7 g of diphenylphosphine oxide (DPPO) are sequentially added into a three-necked flask (the molar ratio of B-1000 to DPPO in the reaction raw materials is 1:9), and react under high-speed stirring at 155° C. for 8 hours with N₂ protection to obtain phosphorus-containing polyolefin resin with the phosphorus content of 9.2 wt % as illustrated in Formula (2), wherein m=2 to 5, n=10 to 15, q=5 to 9.

### Self-Prepared Compound D1:

65 g of Krasol LBH 3000 (polybutadiene resin terminated with hydroxyl group) and 34 g of DOPO are added into flat mouth flask and homogenized at 150° C., and then 1 g of di-tert-butyl peroxide is added into the flat mouth flask to obtain a reaction mixture which is then heated to 160° C. Then, the reaction mixture is cooled to 150° C. and stirred for 4 hours to obtain a white product whose softening point is 105° C. In the white product, the content of the free unreacted DOPO is 1 wt % and the phosphorus content is 5 wt %.

### Self-Prepared Compound D2:

The following D2-1 compound is dissolved into an 85 wt % of hydrogen peroxide solution, wherein the mass ratio of the D2-1 compound to hydrogen peroxide solution is 1:3.

Then, the solution is heated to 60° C. and stirred for 1 hours, followed by filtered and washed with pure water to neutral, and dried to obtain intermediate product D2-2:

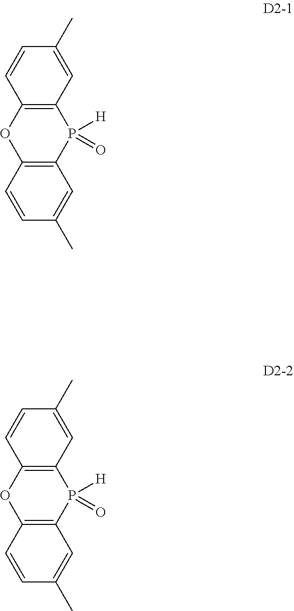 [SMILES: Cc1ccc2c(c1)[PH](=O)c1cc(C)ccc1O2 ; Cc1ccc2c(c1)[PH](=O)c1cc(C)ccc1O2]

26 parts by weight of intermediate product D2-2 is added into 100 parts by weight of POLYVEST@MA75 (maleic anhydride-modified butadiene) and heated to 120° C. under well stirring for 8 hours to obtain a solution. Then, the solution is cooled to room temperature and filtered to remove impurities to obtain a flame retardant product which is a light yellow liquid. In the product, the mass ratio of the backbone of butadiene to the graft group formed by D2-2 is 1:0.208.

### Self-Prepared Compound D3:

The Compound D3 having the formula below:

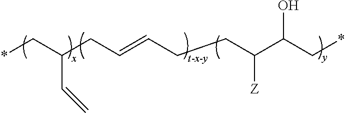

wherein Z is:

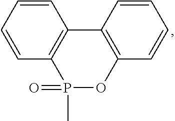

wherein t=600 to 7000; x/t=0.01 to 0.85; y/t=0.05 to 0.30.

### Self-Prepared Compound D4:

The Compound D4 having the formula below:

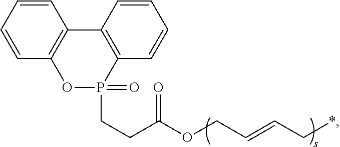

wherein s is 15 to 50.

The contents of the resin composition (in part by weight) of the examples and the comparative examples and the testing results of the properties are illustrated in the following Tables.

TABLE 1
The contents of the resin composition (in part by weight) of the examples
and the testing results of the properties. (PA represents proper amount.)

| component | | E1 | E2 | E3 | E4 | E5 | E6 |
|---|---|---|---|---|---|---|---|
| unsaturated C═C double | SA9000 | 100 | 100 | 100 | 100 | 100 | — |
| bond-containing | OPE-2st | — | — | — | — | — | 100 |
| polyphenylene ether | 2200 | | | | | | |
| | OPE-2st | — | — | — | — | — | — |
| | 1200 | | | | | | |
| phosphorus-containing | P1 | 60 | — | — | — | — | — |
| polyolefin | P2 | — | 20 | 60 | 100 | — | — |
| | P3 | — | — | — | — | 60 | — |
| | P4 | — | — | — | — | — | 60 |
| | P5 | — | — | — | — | — | — |
| | P6 | — | — | — | — | — | — |
| | P7 | — | — | — | — | — | — |
| BVPE | | — | — | — | — | — | — |
| multifunctional vinyl | | — | — | — | — | — | — |
| aromatic copolymer | | | | | | | |
| flame retardant | DOPO | — | — | — | — | — | — |
| | DPPO | — | — | — | — | — | — |
| | Di-DOPO | — | — | — | — | — | — |
| | Di-DPPO | — | — | — | — | — | — |
| curing initiator | 25B | 1.0 | 1.0 | 1.0 | 1.0 | 1.0 | 1.0 |
| inorganic filler | SC2500- | 200 | 200 | 200 | 200 | 200 | 200 |
| | SVJ | | | | | | |
| solvent | toluene | PA | PA | PA | PA | PA | PA |
| property | unit | E1 | E2 | E3 | E4 | E5 | E6 |
| stickiness resistance | / | OK | OK | OK | OK | OK | OK |
| Tg | ° C. | 204 | 215 | 202 | 200 | 206 | 202 |
| Dk | / | 3.21 | 3.28 | 3.22 | 3.18 | 3.15 | 3.25 |
| Df | / | 0.0028 | 0.0026 | 0.0027 | 0.0030 | 0.0026 | 0.0029 |
| flame retardancy | / | V-0 | V-0 | V-0 | V-0 | V-0 | V-0 |
| PCT | / | OOO | OOO | OOO | OOO | OOO | OOO |
| water absorption rate | % | 0.25 | 0.29 | 0.26 | 0.23 | 0.18 | 0.24 |
| P/S | lb/in | 3.3 | 3.8 | 3.2 | 3.1 | 3.1 | 3.5 |
| laminate appearance | / | OK | OK | OK | OK | OK | OK |
| alkali resistance | minute | 15 | 20 | 17 | 15 | 20 | 16 |

TABLE 2
The contents of the resin composition (in part by weight) of the examples
and the testing results of the properties. (PA represents proper amount.)

| component | | E7 | E8 | E9 | E10 | E11 |
|---|---|---|---|---|---|---|
| unsaturated C═C double | SA9000 | — | 100 | 100 | 60 | 70 |
| bond-containing | OPE-2st 2200 | — | — | — | 20 | 15 |
| polyphenylene ether | OPE-2st 1200 | 100 | — | — | 20 | 15 |
| phosphorus-containing | P1 | — | — | — | 20 | — |
| polyolefin | P2 | — | — | — | 20 | 25 |
| | P3 | — | — | — | — | 50 |
| | P4 | — | — | — | — | 5 |
| | P5 | 60 | — | — | — | — |
| | P6 | — | 60 | — | — | — |
| | P7 | — | — | 60 | — | — |
| BVPE | | — | — | — | 10 | — |
| multifunctional vinyl | | — | — | — | — | 10 |
| aromatic copolymer | | | | | | |
| flame retardant | DOPO | — | — | — | — | — |
| | DPPO | — | — | — | — | — |
| | Di-DOPO | — | — | — | 5 | — |
| | Di-DPPO | — | — | — | — | — |
| curing initiator | 25B | 1.0 | 1.0 | 1.0 | 3.0 | 0.5 |
| inorganic filler | SC2500-SVJ | 200 | 200 | 200 | 100 | 250 |
| solvent | toluene | PA | PA | PA | PA | PA |
| property | unit | E7 | E8 | E9 | E10 | E11 |
| stickiness resistance | / | OK | OK | OK | OK | OK |
| Tg | ° C. | 200 | 201 | 200 | 217 | 211 |
| Dk | / | 3.28 | 3.30 | 3.25 | 3.15 | 3.29 |
| Df | / | 0.0030 | 0.0030 | 0.0029 | 0.0027 | 0.0028 |
| flame retardancy | / | V-0 | V-0 | V-0 | V-0 | V-0 |
| PCT | / | OOO | OOO | OOO | OOO | OOO |
| water absorption rate | % | 0.27 | 0.30 | 0.30 | 0.17 | 0.20 |
| P/S | lb/in | 3.5 | 3.4 | 3.5 | 3.5 | 3.6 |
| laminate appearance | / | OK | OK | OK | OK | OK |
| alkali resistance | minute | 14 | 10 | 10 | 16 | 17 |

TABLE 3
The contents of the resin composition (in part by weight) of the comparative examples
and the testing results of the properties. (PA represents proper amount.)

| component | | C1 | C2 | C3 | C4 | C5 |
|---|---|---|---|---|---|---|
| unsaturated C═C double | SA9000 | 100 | 100 | 100 | 100 | 100 |
| bond-containing | OPE-2st | — | — | — | — | — |
| polyphenylene ether | 2200 | | | | | |
| | OPE-2st | — | — | — | — | — |
| | 1200 | | | | | |
| phosphorus-containing | P1 | — | — | — | — | — |
| polyolefin | P2 | — | — | — | — | — |
| | P3 | — | — | — | — | — |
| | P4 | — | — | — | — | — |
| | P5 | — | — | — | — | — |
| | P6 | — | — | — | — | — |
| | P7 | — | — | — | — | — |
| D1 | | 60 | — | — | — | — |
| D2 | | — | 60 | — | — | — |
| D3 | | — | — | 60 | — | — |
| D4 | | — | — | — | 60 | — |
| phosphorus-free | B-1000 | — | — | — | — | 44 |
| polyolefin | B-3000 | — | — | — | — | — |
| | SBS-C | — | — | — | — | — |
| flame retardant | DOPO | — | — | — | — | 16 |
| | DPPO | — | — | — | — | — |
| | Di-DOPO | — | — | — | — | — |
| | Di-DPPO | — | — | — | — | — |
| curing initiator | 25B | 1.0 | 1.0 | 1.0 | 1.0 | 1.0 |
| inorganic filler | SC2500- | 200 | 200 | 200 | 200 | 200 |
| | SVJ | | | | | |
| solvent | toluene | PA | PA | PA | PA | PA |
| property | unit | C1 | C2 | C3 | C4 | C5 |
| stickiness resistance | / | stickiness | powder | stickiness | stickiness | powder |
| | | | falling | | | falling |
| Tg | ° C. | 198 | 195 | 190 | 193 | 170 |
| Dk | / | 3.33 | 3.35 | 3.35 | 3.39 | 3.40 |
| Df | / | 0.0044 | 0.0040 | 0.0043 | 0.0038 | 0.0077 |
| flame retardancy | / | V-0 | V-0 | V-0 | V-1 | V-1 |
| PCT | / | XXX | OOX | XXX | XXX | XXX |
| water absorption rate | % | 0.34 | 0.37 | 0.45 | 0.33 | 0.62 |
| P/S | lb/in | 3.2 | 3.4 | 3.5 | 3.3 | 1.5 |
| laminate appearance | / | OK | OK | OK | OK | yellow spot |
| alkali resistance | minute | 8 | 6 | 6 | 5 | 2 |

TABLE 4
The contents of the resin composition (in part by weight) of the comparative examples
and the testing results of the properties. (PA represents proper amount.)

| component | | C6 | C7 | C8 | C9 | C10 |
|---|---|---|---|---|---|---|
| unsaturated C═C double | SA9000 | 100 | 100 | 100 | 100 | 100 |
| bond-containing | OPE-2st | — | — | — | — | — |
| polyphenylene ether | 2200 | | | | | |
| | OPE-2st | — | — | — | — | — |
| | 1200 | | | | | |
| phosphorus-containing | P1 | — | — | — | — | — |
| polyolefin | P2 | — | — | — | — | — |
| | P3 | — | — | — | — | — |
| | P4 | — | — | — | — | — |
| | P5 | — | — | — | — | — |
| | P6 | — | — | — | — | — |
| | P7 | — | — | — | — | — |
| D1 | | — | — | — | — | — |
| D2 | | — | — | — | — | — |
| D3 | | — | — | — | — | — |
| D4 | | — | — | — | — | — |
| phosphorus-free | B-1000 | — | — | 44 | 44 | 44 |
| polyolefin | B-3000 | 48 | — | — | — | — |
| | SBS-C | — | 45 | — | — | — |
| flame retardant | DOPO | — | — | — | — | — |
| | DPPO | 12 | 15 | — | — | — |
| | Di-DOPO | — | — | 16 | — | — |
| | Di-DPPO | — | — | — | 16 | 80 |
| curing initiator | 25B | 1.0 | 1.0 | 1.0 | 1.0 | 1.0 |
| inorganic filler | SC2500-SVJ | 200 | 200 | 200 | 200 | 200 |
| solvent | toluene | PA | PA | PA | PA | PA |
| property | unit | C6 | C7 | C8 | C9 | C10 |
| stickiness resistance | / | powder | stickiness | powder | powder | powder |
| | | falling | | falling | falling | falling |
| Tg | ° C. | 171 | 174 | 205 | 206 | 195 |
| Dk | / | 3.40 | 3.39 | 3.26 | 3.28 | 3.25 |
| Df | / | 0.0075 | 0.0071 | 0.0024 | 0.0025 | 0.0023 |
| flame retardancy | / | V-1 | V-1 | V-1 | V-1 | V-0 |
| PCT | / | XXX | XXX | OOX | OOX | XXX |
| water absorption rate | % | 0.63 | 0.52 | 0.31 | 0.32 | 0.41 |
| P/S | lb/in | 1.6 | 1.7 | 2.4 | 2.5 | 2.0 |
| laminate appearance | / | yellow | yellow | OK | OK | pattern |
| | | spot | spot | | | |
| alkali resistance | minute | 3 | 2 | 9 | 9 | 6 |

The following observations can be made from Table 1 to Table 4.

1. Compared to Comparative Example C1 which uses phosphorus-containing flame retardant prepared from a polybutadiene resin terminated with hydroxyl group adducted with DOPO and adds unsaturated C═C double bond-containing polyphenylene ether resin, Comparative Example C2 which uses flame retardant formed by phosphorus-containing compound, except DOPO and DPPO, grafted onto an anhydride-modified butadiene and adds unsaturated C═C double bond-containing polyphenylene ether resin, Comparative Example C3 which uses flame retardant obtained from the reaction of DOPO with epoxidized polybutadiene and adds unsaturated C═C double bond-containing polyphenylene ether resin, and Comparative Example C4 which uses flame retardant obtained from the reaction of DOPO with acrylate and then reacted with polybutadiene terminated with hydroxyl group and adds unsaturated C═C double bond-containing polyphenylene ether resin, Examples E1 to E11 which use phosphorus-containing polyolefin (polybutadiene adducted with DPPO or DOPO, styrene-butadiene copolymer adducted with DPPO or DOPO) and add unsaturated C═C double bond-containing polyphenylene ether resin have a significant improvement in the following properties: stickiness resistance, Tg, Dk, Df, PCT, water absorption rate, and alkali resistance. Among them, stickiness and powder falling do not occur in the specimens of Examples E1 to E11, stickiness occurs in the specimens of Comparative Example C1 and Comparative Examples C3 to C4, powder falling occurs in C2, Tg of the specimens of Examples E1 to E11 are all greater than or equal to 200° C., Tg of the specimens of Comparative Examples C1 to C4 are all less than 200° C., Dk of the specimens of Examples E1 to E11 are all less than or equal to 3.3, Dk of the specimens of Comparative Examples C1 to C4 are all greater than 3.3, Df of the specimens of Examples E1 to E11 are all less than or equal to 0.0030, Df of the specimens of Comparative Examples C1 to C4 are all greater than 0.0030, delamination occurs in PCT of the specimens of Comparative Examples C1 to C4, no delamination occurs in PCT of the specimens of Examples E1 to E11, the water absorption rates of the specimens of Examples E1 to E11 are all less than or equal to 0.30%, the water absorption rates of the specimens of Comparative Examples C1 to C4 are all greater than 0.30%, alkali resistance of the specimens of Examples E1 to E11 are all greater than or equal to 10 minutes, and alkali resistance of the specimens of Comparative Examples C1 to C4 are all less than 10 minutes.

2. Compared to Comparative Examples C5 to C7 (which replace the phosphorus-containing polyolefin used in Examples E1 to E11 with DOPO or DPPO and polybutadiene or styrene-butadiene copolymer which are directedly added without performing a reaction, and mixed with unsaturated C═C double bond-containing polyphenylene ether resin), Examples E1 to E11 which use phosphorus-containing polyolefin (polybutadiene adducted with DPPO or DOPO, styrene-butadiene copolymer adducted with DPPO or DOPO) and add unsaturated C═C double bond-containing polyphenylene ether resin have a significant improvement in the following properties: stickiness resistance, Tg, Dk, Df, flame retardancy, PCT, water absorption rate, P/S, laminate appearance, and alkali resistance. Compared to Comparative Examples C8 to C9 (which replace the phosphorus-containing polyolefin used in Examples E1 to E11 with phosphorus-free polyolefin together with conventional additive type flame retardant (Di-DOPO, Di-DPPO) and mixed with unsaturated C═C double bond-containing polyphenylene ether resin), Examples E1 to E11 have a significant improvement in the following properties: stickiness resistance, flame retardancy, PCT, water absorption rate, P/S, and alkali resistance. Among them, stickiness and powder falling do not occur in the specimens of Examples E1 to E11, powder falling occurs in the specimens of Comparative Examples C8 to C9, the flame retardancy of the specimens of Examples E1 to E11 is V0, the flame retardancy of the specimens of Comparatives Examples C8 to C9 is V1, delamination occurs in PCT of the specimens of Comparative Examples C8 to C9, no delamination occurs in PCT of the specimens of Examples E1 to E11, water absorption rate of the specimens of Examples E1 to E11 are all less than or equal to 0.30%, water absorption rate of the specimens of Comparative Example C8 to C9 are all greater than 0.30%, P/S (copper foil peeling strength) of the specimens of Examples E1 to E11 are all greater than or equal to 3.1 lb/in, P/S (copper foil peeling strength) of the specimens of Comparative Example C8 to C9 are all less than 3.1 lb/in, alkali resistance of the specimens of Examples E1 to E11 are all greater than or equal to 10 minutes, alkali resistance of the specimens of Comparative Example C1 to C4 are all less than 10 minutes.

3. Comparative Example C10 which uses phosphorus-free polyolefin, conventional additive type flame retardant and unsaturated C═C double bond-containing polyphenylene ether resin. In order to meet the requirements of flame retardancy, Comparative Example C10 has a higher additive amount of flame retardant Di-DOPO as compared to Comparative Example C9, while other properties have not been improved as compared to Comparative Example C9. In addition, compared to Comparative Example C10, Examples E1 to E11 which use phosphorus-containing polyolefin together with unsaturated C═C double bond-containing polyphenylene ether have a significant improvement in the following properties: stickiness resistance, Tg, PCT, water absorption rate, P/S, laminate appearance, and alkali resistance. Among them, stickiness and powder falling do not occur in all of the specimens of Examples E1 to E11, powder falling occurs in the specimens of Comparative Example C10, Tg of the specimens of Examples E1 to E11 are all greater than or equal to 200° C., Tg of the specimens of Comparative Example C10 are less than 200° C., delamination occurs in PCT of the specimens of Comparative Example C10, no delamination occurs in PCT of the specimens of Examples E1 to E11, the water absorption rates of the specimens of Examples E1 to E11 are all less than or equal to 0.30%, the water absorption rates of the specimens of Comparative Example C10 are greater than 0.30%, P/S (copper foil peeling strength) of the specimens of Examples E1 to E11 are all greater than or equal to 3.1 lb/in, P/S (copper foil peeling strength) of the specimens of Comparative Example C10 are less than 3.1 lb/in, neither pattern nor yellow spot occurs on the laminate appearance of the specimens of Examples E1 to E11, pattern occurs on the laminate appearance of the specimens of Comparative Example C10, alkali resistance of the specimens of Examples E1 to E11 are all greater than or equal to 10 minutes, and alkali resistance of the specimens of Comparative Example C10 are less than 10 minutes.

4. In the Examples E1 to E11 described above, E1 to E7 and E10 to E11 are compared respectively with E8 to E9. Each of the performance of the article made from the resin composition is significantly improved, particularly having a lower water absorption rate and a better alkali resistance.

What is claimed is:

1. A resin composition, comprising:
(A) 100 parts by weight of an unsaturated C═C double bond-containing polyphenylene ether resin; and
(B) 20 parts by weight to 100 parts by weight of a phosphorus-containing polyolefin resin, wherein the phosphorus-containing polyolefin resin consists of (a) structural unit and (b) structural unit, and/or, consists of (a) structural unit, (b) structural unit, and (c) structural unit, wherein (a) structural unit comprises any one of (a1) structural unit, (a2) structural unit, or a combination thereof, and (b) structural unit comprises any one of (b1) structural unit, (b2) structural unit, or a combination thereof, 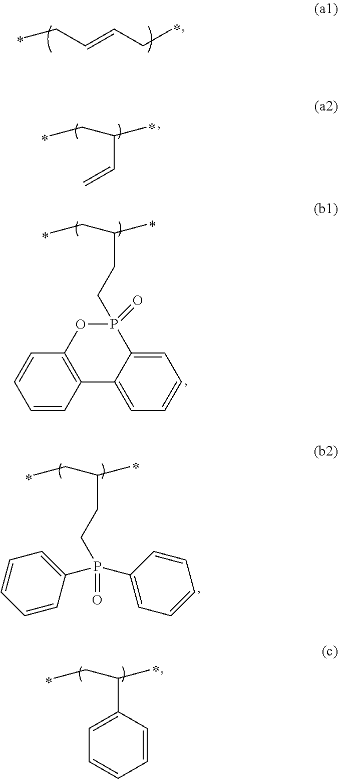
wherein symbol “*” represents a bonding position between the structural units.

2. The resin composition according to claim 1, wherein the unsaturated C═C double bond-containing polyphenylene ether resin comprises any one of a vinylbenzyl group-containing polyphenylene ether resin, a (meth)acryloyl group-containing polyphenylene ether resin, a vinyl group-containing polyphenylene ether resin, or a combination thereof.

3. The resin composition according to claim 1, wherein the phosphorus content in the phosphorus-containing polyolefin resin is 3 to 10 percentage by weight.

4. The resin composition according to claim 1, wherein the phosphorus content in the phosphorus-containing polyolefin resin is 3.1 to 4.0 percentage by weight.

5. The resin composition according to claim 1, wherein the phosphorus-containing polyolefin resin comprises any one of a phosphorus-containing polyolefin resin represented by Formula (1), a phosphorus-containing polyolefin resin represented by Formula (2), a phosphorus-containing polyolefin resin represented by Formula (3), a phosphorus-containing polyolefin resin represented by Formula (4), a phosphorus-containing polyolefin resin represented by Formula (5), a phosphorus-containing polyolefin resin represented by Formula (6), a phosphorus-containing polyolefin resin represented by Formula (7), a phosphorus-containing polyolefin resin represented by Formula (8), or a combination thereof, 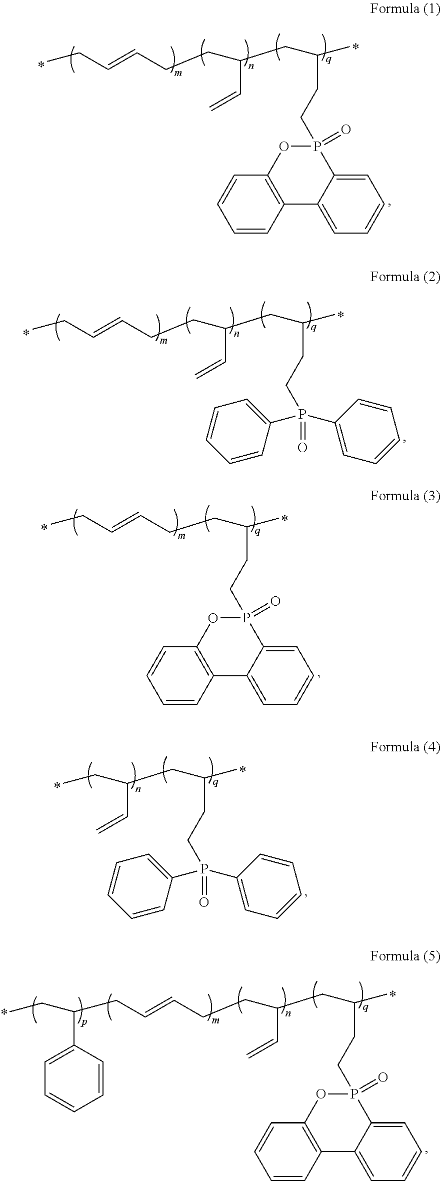 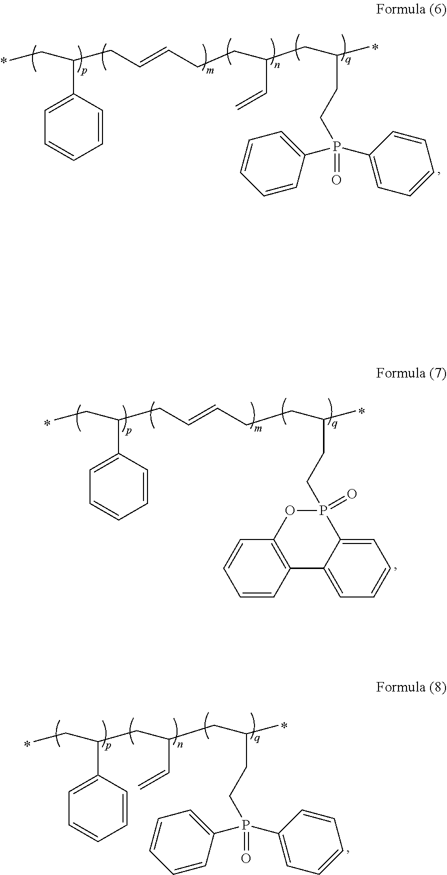
wherein, in Formula (1) to Formula (8), symbol “*” represents a bonding position between the structural units, and each of p, m, n, or q is independent, wherein p is an integer of 1 to 200, m is an integer of 2 to 200, n is an integer of 10 to 400, q is an integer of 1 to 100.

6. The resin composition according to claim 1, wherein the resin composition further comprises an unsaturated C═C double bond-containing crosslinking agent, and the unsaturated C═C double bond-containing crosslinking agent is any one of a bis(vinylphenyl)ethane, a bis(vinylbenzyl) ether, a divinylbenzene, a divinylnaphthalene, a divinylbiphenyl, a triallyl isocyanurate, a triallyl cyanurate, a trivinylcyclochexane, a diallyl bisphenol A, a butadiene, a decadiene, an octadiene, an acrylate having two or more funtional groups, or a combination thereof.

7. The resin composition according to claim 1, wherein the resin composition further comprises any one of a phosphorus-free polyolefin, a maleimide resin, a benzoxazine resin, an epoxy resin, an organic silicone resin, a cyanate ester resin, an active ester, a phenol resin, an amine curing agent, a styrene maleic anhydride, a polyamide, a polyimide, or a combination thereof.

8. The resin composition according to claim 1, wherein the resin composition further comprises any one of a flame retardant, a curing accelerator, a polymerization inhibitor, an inorganic filler, a solvent, a silane coupling agent, a surfactant, a coloring agent, a toughening agent, or a combination thereof.

9. An article made from the resin composition according to claim 1, comprising a prepreg, a resin film, a laminate, or a printed circuit board.

10. The article according to claim 9, wherein the article has a dielectric constant at 10 GHz as measured by reference to JISC2565 of less than or equal to 3.30.

11. The article according to claim 9, wherein the article has a dissipation factor at 10 GHz as measured by reference to JISC2565 of less than or equal to 0.0030.

12. The article according to claim 9, wherein the article has a glass transition temperature as measured by reference to IPC-TM-650 2.4.24.4 of greater than or equal to 200° C.

13. The article according to claim 9, wherein the article has a flame retardancy as measured by reference to UL94 rating of V0.

14. The article according to claim 9, wherein the article has no delamination that occurs after subjecting the article to a thermal resistance after moisture absorption test by reference to IPC-TM-650 2.6.16.1 and IPC-TM-650 2.4.23.

15. The article according to claim 9, wherein the article has a water absorption rate as measured by reference to IPC-TM-650 2.6.2.1 and IPC-TM-650 2.6.16.1 of less than or equal to 0.30%.

16. The article according to claim 9, wherein the article has a copper foil peeling strength as measured by reference to IPC-TM-650 2.4.8 of greater than or equal to 3.1 lb/in.
